(19) United States
(12) Patent Application Publication
(10) Pub. No.: US 2004/0207190 A1
(43) Pub. Date: Oct. 21, 2004

(54) Body frame for an off-road vehicle

(75) Inventors: Mitsuo Nakagawa, Wako-shi (JP); Yuji Maki, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 10/800,184

(22) Filed: Mar. 11, 2004

(30) Foreign Application Priority Data
Mar. 12, 2003 (JP) 2003-067201

(51) Int. Cl. B62D 21/00

(52) U.S. Cl. 280/781

(57) ABSTRACT

A body frame for an off-road vehicle includes two upper arm installation areas. An upper horizontal member extends between two upper arm installation areas. A second coupling member extends between the two upper arm installation areas above the upper horizontal member. A shock absorber supporting portion for supporting a shock absorber is provided at the apex portion of this second coupling member.

### BACKGROUND OF THE INVENTION

1. Field of the Invention

The present invention relates to body frame structure of an off-road driving vehicle.

2. Description of the Related Art

Japanese Patent Publication No. 6-86230 (p. 5, FIG. 3) describes a body frame structure of an off-road land driving vehicle provided with an arm installation area for installing an arm which supports a wheel in such a manner as to be freely swingable. The reference also depicts a shock absorber supporting portion for supporting a shock absorber.

FIG. 9 depicts FIG. 3 of the reference, with the terms and reference numbers altered where necessary for convenience or clarity. Body frame structure 200 of an off-road driving vehicle includes an inverse L-shaped main frame 203 having a vertical pipe portion 201 and a horizontal pipe portion 202. A rear frame 204 extends downward from this main frame 203. A lower frame 205 connects the main frame 203 to the rear frame 204. A center frame 206 connects an intermediate of the vertical pipe portion 201 of the main frame 203 to an immediate of the lower frame 205. Two upper arm installation areas 208, 209, for installing an upper arm (not shown) in such a manner as to be freely swingable, are provided in front of the center frame 206. Two lower arm installation areas 212, 213, for installing a lower arm (not shown) in such a manner as to be freely swingable, are provided in front of the lower frame 205. A shock absorber supporting portion 214 supports a shock absorber (not shown) on the vertical pipe portion 201. In this respect, each of the upper arm and the lower arm is a member for supporting the front wheel 215 in such a manner as to be freely swingable.

The above-described body frame structure, however, has several drawbacks. Since the main frame 203 has been provided with the shock absorber supporting portion 214, the main frame 203 will be affected when a specification of the shock absorber is changed. Accordingly, this limits the degree of freedom available in altering the design of the vehicle.

Also, in order to enhance the rigidity of the shock absorber supporting portion 214, the upper arm installation areas 208, 209, and the lower arm installation areas 212, 213 on which a load is concentrated, it is necessary to increase the wall thickness of the main frame 203 or to add a reinforcement member and the like. This causes an undesirable increase in the weight of the vehicle.

Thus, it is an object of the present invention to provide a body frame structure of an off-road driving vehicle capable of increasing the degree of freedom in design while, at the same time, enhancing the rigidity of the vehicle without an undesirable increase in the vehicle weight.

### SUMMARY OF THE INVENTION

The present invention addresses the problems identified above. The present invention provides a body frame structure with increased rigidity while keeping a weight increase of the vehicle to a minimum. Such an increase in rigidity is desirable because it improves the handling of the vehicle. Also, the present invention provides a body frame structure that easily copes with many types of designs, which increases the degree of freedom available in the design of the vehicle.

Thus, between one upper arm installation area and the other upper arm installation area, there is laid a first coupling member over, and above this first coupling member. Also, between one upper arm installation area and the other upper arm installation area, there is laid a substantially V-shaped second coupling member over. Accordingly, the two upper arm installation areas, to which a load is applied, have been made into a substantially triangular truss structure. As a result, it is possible to enhance the rigidity of the body frame while keeping the weight increase of the vehicle to a minimum.

Also, by providing a shock absorber supporting portion for supporting a shock absorber at an apex portion of the second coupling member, when changing the shock absorber, it is possible to alter the design to fit by changing only the front frame. As a result, it is possible to easily alter the design without severe restrictions on the degree of freedom of the design.

The invention also provides a structure of a joint for connecting the upper main pipe is provided in the neighborhood of an apex portion of the second coupling member. The joint for connecting the upper main pipe is provided in the neighborhood of the apex portion of the second coupling member. Therefore, it is possible to extend the upper main pipe from a portion that has enhanced rigidity. As a result, it is possible to further improve the rigidity of the entire body frame.

The upper arm installation area, the lower arm installation area, the first and second coupling members, the shock absorber supporting portion and the joint can be integrally formed by casting. Therefore, the number of components can be reduced. As a result, the cost of the body frame can be reduced. This also improves position accuracy of these parts during manufacture, which improves the ease with which the vehicle can be assembled.

### BRIEF DESCRIPTION OF THE DRAWINGS

FIG. 1 is a side view showing an off-road driving vehicle, for which the body frame structure according to the present invention has been adopted;

FIG. 2 is a plan view showing an off-road driving vehicle for which the body frame structure according to the present invention has been adopted;

FIG. 3 is a perspective view showing body frame structure of an off-road driving vehicle according to the present invention;

FIG. 4 is a side view showing body frame structure of an off-road driving vehicle according to the present invention;

FIG. 5 is a perspective view showing a front frame assembly of body frame structure of an off-road driving vehicle according to the present invention;

FIG. 6 is an exploded perspective view showing a lower arm of body frame structure of an off-road driving vehicle according to the present invention;

FIG. 7 is a cross-sectional view taken on line 7-7 of FIG. 5;

FIG. 8 is a side view showing a front frame of body frame structure of an off-road driving vehicle according to the present invention; and

FIG. 9 shows a traditional body frame structure of an off-road driving vehicle.

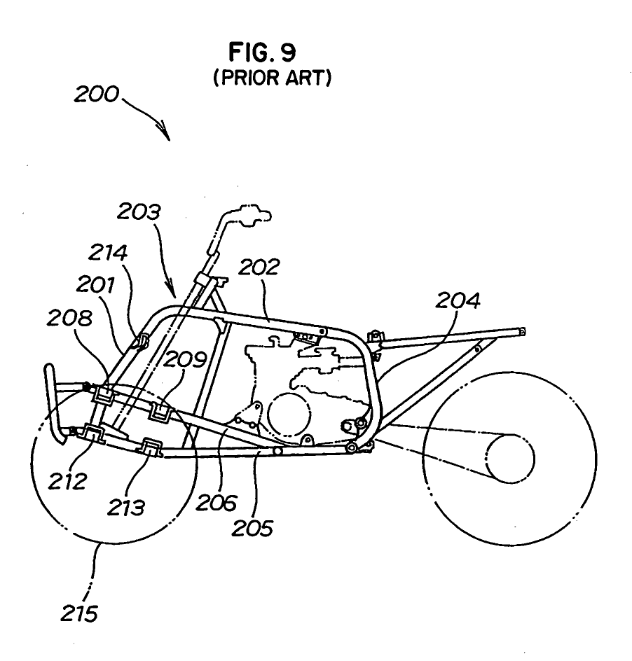

### DETAILED DESCRIPTION OF THE INVENTION

Hereinafter, with reference to the accompanying drawings, an embodiment of the present invention will be described.

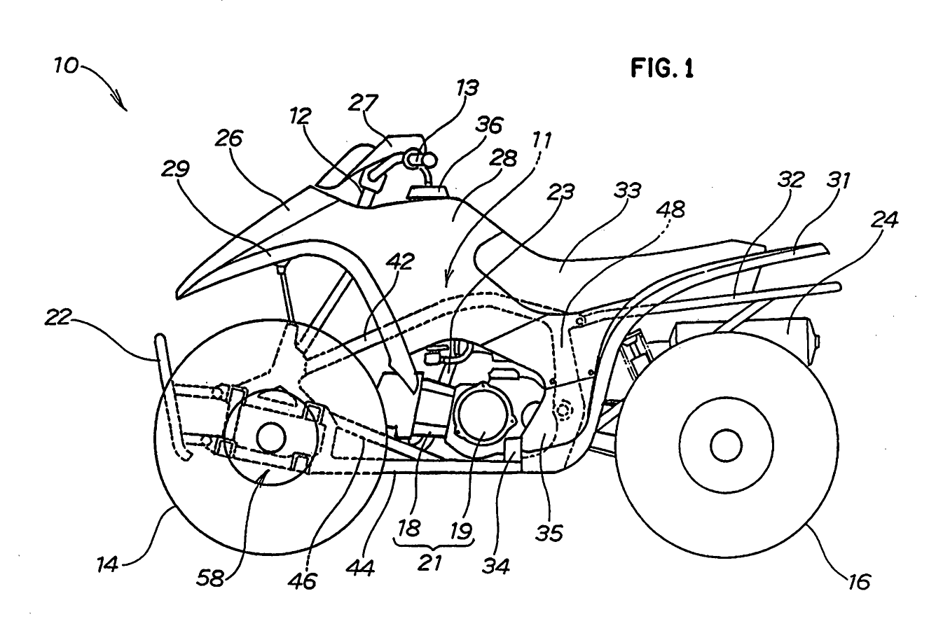

FIG. 1 is a side view showing an off-road driving vehicle, for which a body frame structure according to the present invention has been adopted. The off-road driving vehicle 10 is a vehicle for driving on an uneven surface. A handlebar post 12 is installed on the front portion of the body frame 11. A handlebar 13 is rotatively installed on the handlebar post 12. Front wheels 14, 15 (only the front wheel 14 of this side is shown) are left and right wheels rotatively installed to the lower end of the front portion of the body frame 11. Left and right rear wheels 16, 17 (only the rear wheel 16 of this side is shown) are rotatively installed to the lower end of the rear portion of the body frame 11. In order to drive these front wheels 14, 15 and rear wheels 16, 17, a power unit 21 consisting of the engine 18 and transmission 19 is installed at an intermediate portion of the body frame 11.

In FIG. 1, reference numeral 22 designates a front guard for protecting the front surface of the vehicle body; 23 designates an exhaust pipe connected to the front portion of the engine 18; 24 designates a muffler connected to the exhaust pipe; 26 designates a front cover; 27 designates a handlebar cover; 28 designates a side cover; 29 designates a front fender; 31 designates a rear fender; 32 designates a seat rail extending toward the rear from left and right of the body frame; 33 designates a seat; 34 designates a step bar; 35 designates a rear mud guard; and 36 designates a fuel cap.

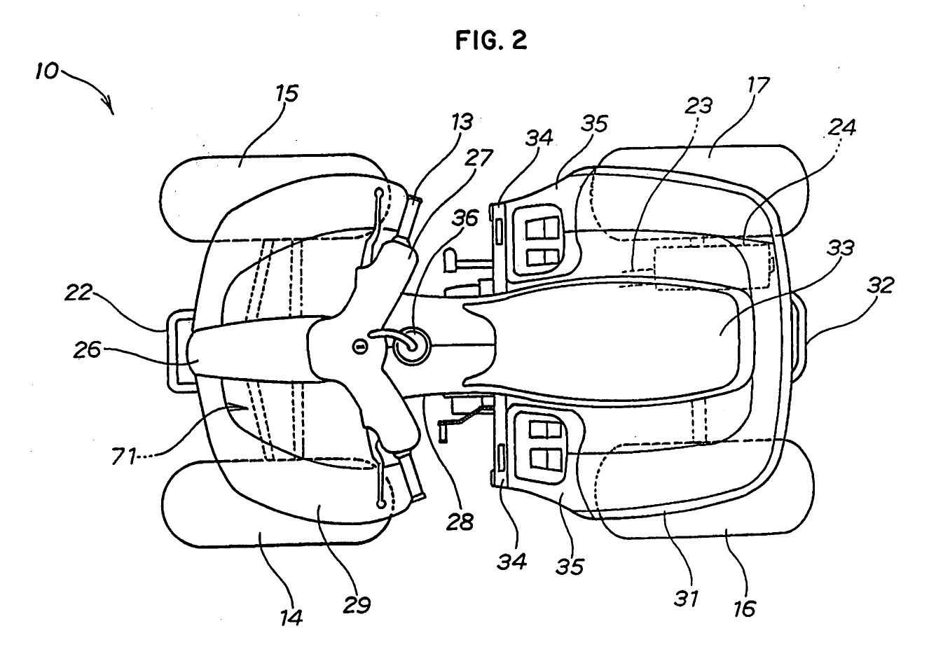

FIG. 2 is a plan view showing an off-road driving vehicle for which a body frame structure according to the present invention has been adopted. At the center of a front portion of the body frame 11, there is provided a front cover 26. On the left and right of this front cover, there are side covers 28. A front fender 29 is provided at the base portion of this side cover 28. An upper portion in the rear between the left and right front wheels 14 and 15 is covered with the front cover 26, side covers 28 and front fender 29. A seat 33 is arranged behind the side cover 28. A rear fender 31 extends from both ends and rear end of this seat 33. There are left and right step bars 34, 34 for placing the driver's feet below the front end of the seat 33. Behind these step bars 34, 34, there are rear mud guards 35, 35 for preventing splash from the rear wheels.

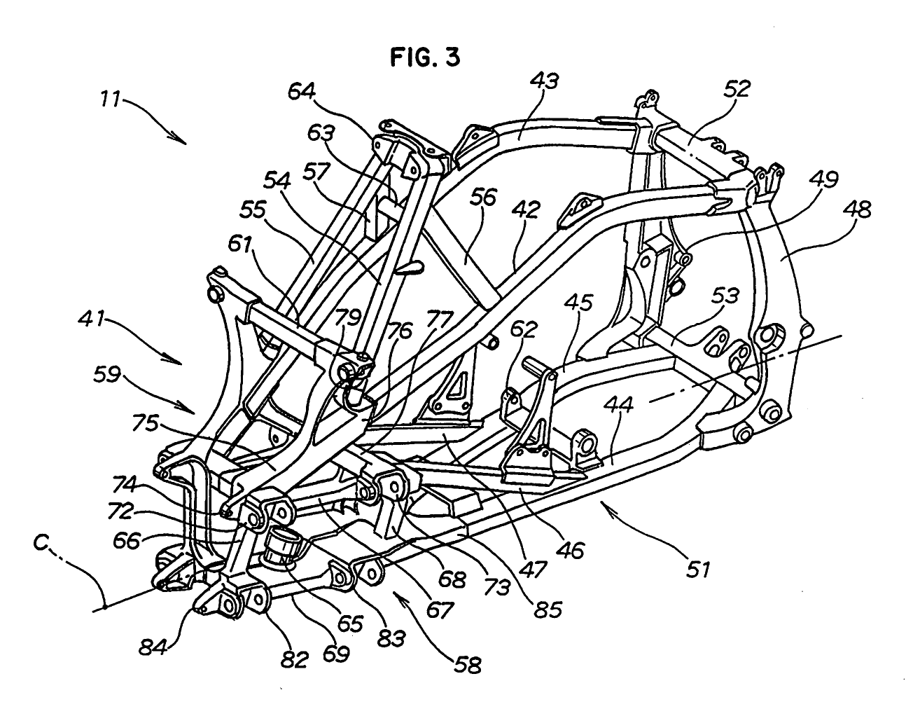

FIG. 3 is a perspective view showing a body frame structure of an off-road driving vehicle according to the present invention.

The vehicle frame 11 is a substantially bilaterally symmetrical frame mainly composed of: a front frame assembly 41 for rotatively supporting a handlebar 13 (See FIG. 1) and supporting front wheels 14, 15 in such a manner as to be freely swing-able; left and right upper main pipes 42, 43 for extending backward from the upper portion of this front frame assembly 41; left and right lower main pipes 44, 45 for extending backward from the lower portion of the front frame assembly 41; left and right coupling frames 46, 47 for connecting left and right rear portions of the front frame assembly 41 to intermediates of the left and right lower main pipes 44, 45 respectively; a left rear frame 48 for connecting a rear end of the left upper main pipe 42 to a rear end of the left lower main pipe 44; a right rear frame 49 for connecting the rear end of the right upper main pipe 43 to the rear end of the right lower main pipe 45; an upper cross member 52 for connecting upper ends of these left and right rear frames 48, 49; a lower cross member 53 for connecting lower ends of the left and right rear frames 48, 49; left and right handlebar post supporting pipes 54, 55 for obliquely rising from the left and right rear portions of the front frame assembly 41; and left and right supporting pipe stays 56, 57 for connecting these left and right handlebar supporting pipes 54, 55 to the left and right upper main pipes 42, 43 respectively. In FIG. 3, reference symbol C designates a frame center of the body frame 11.

The front frame assembly 41 is composed of the left and right front frames 58, 59, which are formed by casting, and a front cross member 61 laid over between the upper portions of these left and right front frames 58 and 59.

In FIG. 3, reference numeral 62 designates an intermediate cross member for connecting intermediates of the left and right lower main pipes 44, 45; 63 designates a cross member for a stay for connecting the left and right supporting pipe stays 56, 57; 64 designates an upper supporting portion for rotatively supporting the handlebar post 12 (See FIG. 1); and 65 designates a lower supporting portion for rotatively supporting the handlebar post 12.

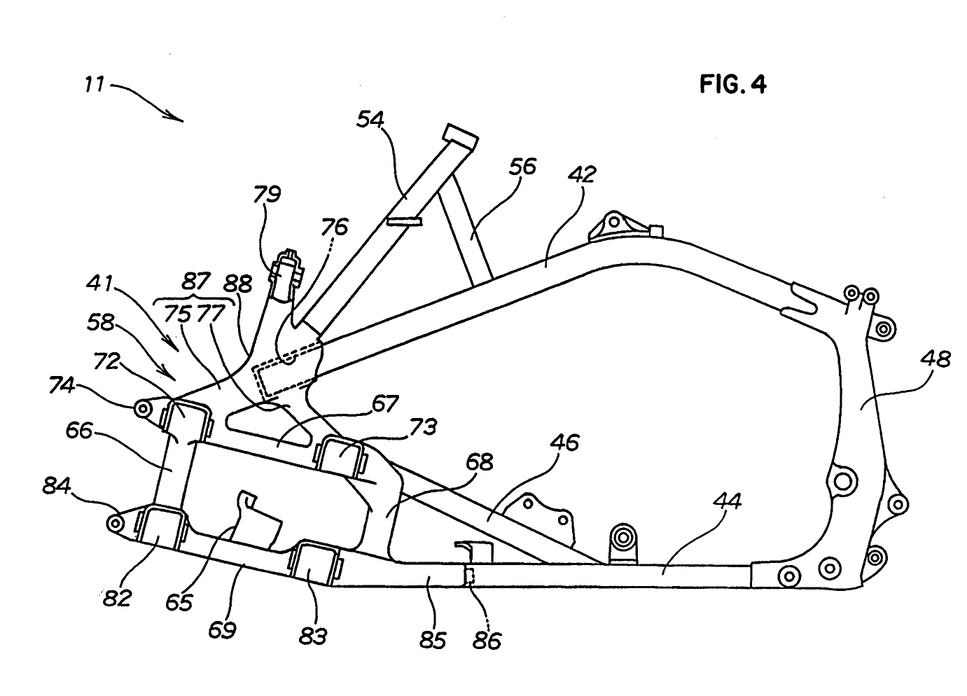

FIG. 4 is a side view showing body frame structure of an off-road driving vehicle according to the present invention.

A left front frame 58 is composed of; a front vertical portion 66; an upper horizontal portion 67 as a first coupling member, extending backward from one end of the front vertical portion 66; a rear vertical portion 68 hanging from a tip end of the upper horizontal portion 67; and a lower horizontal portion 69 for extending forward from the tip end of the rear vertical portion 68 to be connected to the other end of the front vertical portion 66.

In this respect, a substantially rectangular left frame body 51 when observed from its side is constituted by: the left front frame 58; the left upper main pipe 42; the left lower main pipe 44; and the left rear frame 48. Also, similarly, a substantially rectangular right frame body (not shown) when observed from its side is constituted by: the right front frame 59 (See FIG. 3); the right upper main pipe 43; the right lower main pipe 45; and the right rear frame 49.

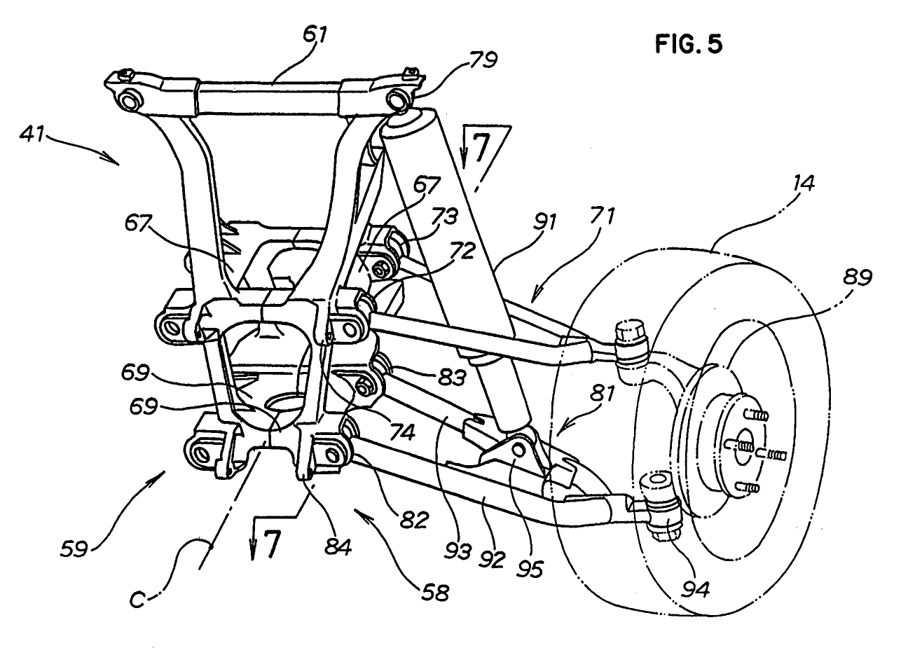

The upper horizontal portion 67 has: two upper arm installation areas 72, 73 for installing an upper arm 71 (See FIG. 5) for supporting the front wheel 14 in such a manner as to be freely swingable; an upper installation area 74 for installing an upper portion of the front guard 22 (See FIG. 1) that protruding from the front end; an upper connecting pipe 75 as a joint for installing the left upper main pipe 42 by obliquely extending backward from the front end; an upper main pipe installation area 76 provided at the tip end of the upper connecting pipe 75; a stay pipe portion 77 for connecting the upper main pipe installation area 76 to the rear end; and a shock absorber supporting portion 79 for supporting the shock absorber 91 (See FIG. 5) on top of the upper main pipe installation area 76.

In this respect, a substantially V-shaped second coupling member 87 is constituted by the upper connecting pipe 75 and the stay pipe portion 77. Also, reference numeral 88 designates an apex portion of the second coupling member 87.

In other words, the body frame 11 can be said to be the upper connecting pipe (joint) 75 for connecting the upper main pipe 42 provided in the neighborhood of an apex portion 88 of the second coupling member 87.

The upper connecting pipe 75 for connecting the upper main pipe 42 has been provided in the neighborhood of an apex portion 88 of the second coupling member 87, whereby the upper main pipe 42 can be extended from a portion, the rigidity of which has been enhanced. As a result, it is possible to improve the rigidity of the overall body frame 11.

The lower horizontal portion 69 is composed of: two lower arm installation areas 82, 83 for installing a lower arm 81 for supporting the front wheel 14 in such a manner as to be freely swingable; a lower installation area 84 for installing a lower portion of the front guard 22 (See FIG. 1) for protruding from the front end; a lower connecting pipe 85 for installing the left lower main pipe 44 by protruding from the rear end; and a lower main pipe installation area 86 provided at the tip end of this lower connecting pipe 85.

The right front frame 59 (See FIG. 3) is a symmetrical member to the left front frame 58, and a detailed description will therefore be omitted.

FIG. 5 is a perspective view showing a front frame assembly of body frame structure of an off-road driving vehicle according to the present invention. The front frame assembly 41 is obtained by welding front ends of the upper horizontal portions 67, 67 of the left and right front frames 58, 59 in the frame center C, welding rear ends of the upper horizontal portions 67, 67 in the frame center C, and welding lower horizontal portions 69, 69 of the left and right front frames 58, 59 in the frame center C to thereby be integrally assembled.

The left front frame 58 is obtained by providing an upper portion of the left front frame 58 on the side with two upper arm installation areas 72, 73 in order to install the upper arm 71 for supporting the front wheel 14 in such a manner as to be freely swingable, and by providing a lower portion of the left front frame 58 on the side with two lower arm installation areas 82, 83 in order to install the lower arm 81 for supporting the front wheel 14 in such a manner as to be freely swingable. Also, the left front frame 58 can be said to be a member for interposing a shock absorber 91 between the shock absorber supporting portion 79 and the lower arm 81 by installing a knuckle 89 to a tip end of the upper arm 71 and a tip end of the lower arm 81 and rotatively installing the front wheel 14 to this knuckle 89.

In this respect, the right front frame 59 is a portion for installing the upper arm, the lower arm and the knuckle, which are not shown, similarly to the left front frame 57.

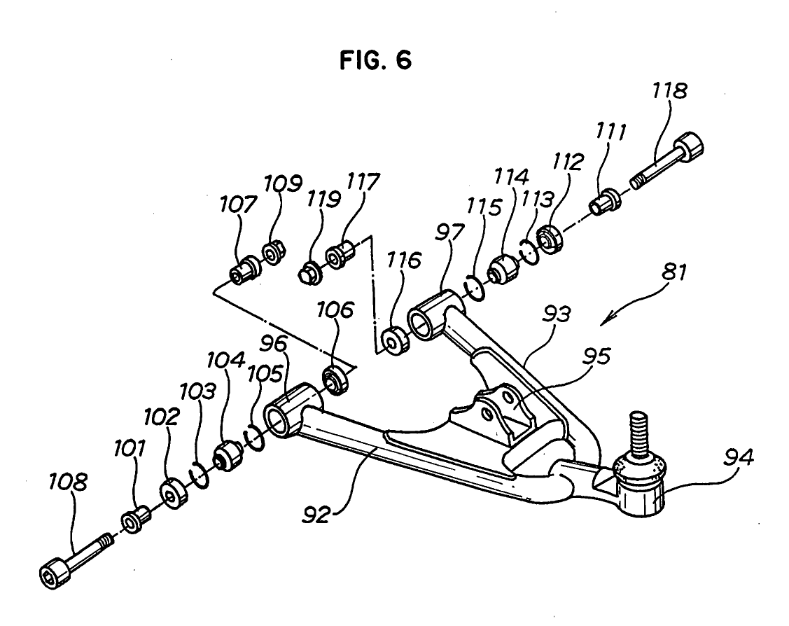

FIG. 6 is an exploded perspective view showing a lower arm of body frame structure of an off-road driving vehicle according to the present invention. The lower arm 81 is a substantially V-shaped arm comprised of: one arm portion 92; another arm portion 93; a knuckle installation area 94 provided at the tip ends of these arm portions 92, 93; a shock absorber receiving unit 95 provided midway between the arm portions 92, 93; and two fitted portions 96, 97 for fitting in two lower arm installation areas 82, 83 (See FIG. 5) by forming at the bases of the arm portions 92, 93 respectively.

In FIG. 6, reference numerals 101, 111 designate collars; 102, 112 designate sealing material; 103, 113 designate stopper rings; 104, 114 designate bearings; 105, 115 designate stopper rings; 106, 116 designate sealing material; 107, 117 designate collars; 108, 118 designate bolts; and 109, 119 designate nuts.

Also, the upper arm 71 (See FIG. 5) is an arm of substantially the same structure in which the shock absorber receiving unit 95 has been omitted from the lower arm 81, and a detailed description will be omitted.

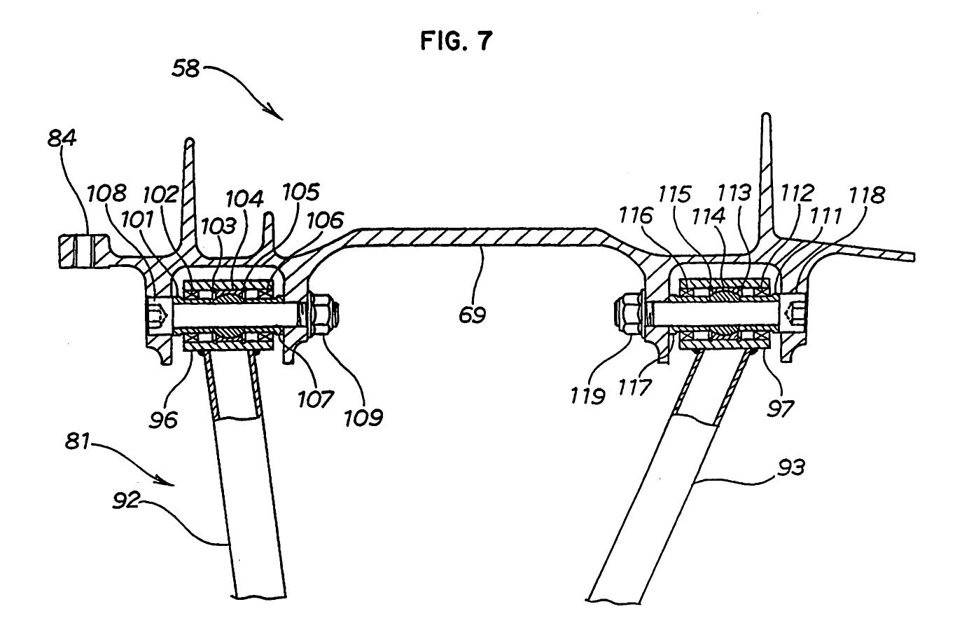

FIG. 7 is a cross-sectional view taken on line 7-7 of FIG. 5, and shows a plan cross-section for two lower arm installation areas. The collar 101, the sealing material 102, the stopper ring 103, the bearing 104, and the stopper ring 105 are inserted into the fitted portion 96 from one side. The sealing material 106 and the collar 107 are inserted from the other side. The bolt 108 is caused to penetrate these members. The nut 109 is screwed into this bolt 108. The collar 111, the sealing material 112, the stopper ring 113, the bearing 114, and the stopper ring 115 are inserted into the fitted portion 97 from the other side. The sealing material 116 and the collar 117 are inserted from one side. The bolt 118 is caused to penetrate these members. The nut 119 is screwed into this bolt 118, whereby the lower arm 81 is installed to those two lower arm installation areas 82, 83 in such a manner as to be freely swingable.

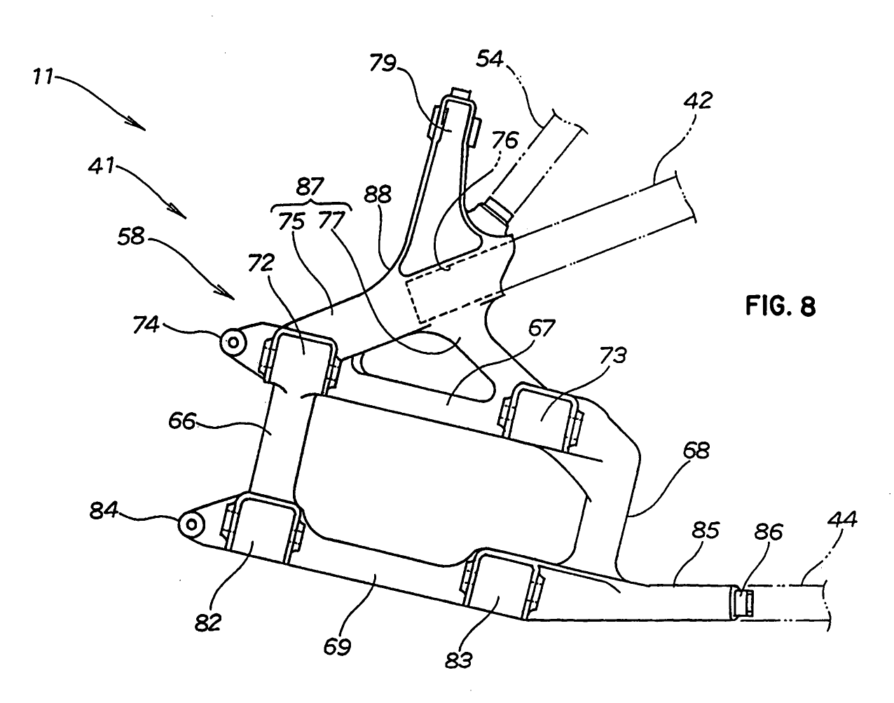

FIG. 8 is a side view showing a front frame of body frame structure of an off-road driving vehicle according to the present invention. The body frame 11 can be said to be body frame structure, in which a substantially rectangular frame body 51, when observed from its side, is constituted by extending an upper main pipe 42 backward from the upper portion of the front frame 58, extending a lower main pipe 44 backward from a lower portion of the front frame 58, and coupling tip portions of these upper and lower main pipes 42, 44 through the rear frame 48 (See FIG. 4). In order to install an upper arm 71 for supporting a front wheel 14 (See FIG. 5) in such a manner as to be freely swingable, the upper portion of the front frame 58 on the side is provided with two upper arm installation areas 72, 73. In order to install a lower arm 81 (See FIG. 5) for supporting the front wheel 14 in such a manner as to be freely swingable, the lower portion of the front frame 58 on the side is provided with two lower arm installation areas 82, 83, characterized in that the front frame 58 is provided with: an upper horizontal portion (a first coupling member) 67 laid over between one upper arm installation area 72 and the other upper arm installation area 73; a substantially V-shaped second coupling member 87 (upper connecting pipe 75 and stay pipe portion 77) laid over between one upper arm installation area 72 and the other upper arm installation area 73, above this upper horizontal portion 67 the first coupling member; and a shock absorber supporting portion 79 for supporting a shock absorber 91 (See FIG. 5) by providing it at the apex portion 88 of this second coupling member 87.

It is desirable to provide a body frame structure capable of enhancing the rigidity while restricting an increase in vehicle weight to a minimum, as this would improve the running characteristics of the vehicle. Also, it is desirable to provide a body frame structure capable of easily coping with many types of shock absorbers in order to increase the degree of freedom available in the design of the vehicle.

Thus, between one upper arm installation area 72 and the other upper arm installation area 73, there is laid an upper horizontal portion (first coupling member) 67. Over and above this upper horizontal portion 67, between upper arm installation areas 72 and 73, there is laid a substantially V-shaped second coupling member 87. Therefore, that area, to which a load is applied, have been made into a substantially triangular truss structure. As a result, it is possible to enhance the rigidity of the body frame 11 while keeping any increase in vehicle weight to a minimum.

Also, by providing a shock absorber supporting portion 79 for supporting a shock absorber 91 (See FIG. 5) at an apex portion 88 of the second coupling member 87, when changing the shock absorber 91, it is possible to manage this change by only changing the front frame 58. As a result, it is possible to easily manage the type of shock absorber without restricting the degree of freedom in design.

Further, the body frame 11 can be said to be frame obtained by integrally forming the upper arm installation areas 72, 73, the lower arm installation areas 82, 83, first coupling member (upper horizontal portion) 67, the second coupling member 87, the shock absorber supporting portion 79 and the joint (upper connecting pipe) 75 by casting.

The upper arm installation areas 72, 73, the lower arm installation areas 82, 83, the first coupling member (upper horizontal portion) 67, the second coupling member 87, the shock absorber supporting portion 79 and the joint (upper connecting pipe) 75 are integrally formed by casting. Therefore, the number of components can be reduced. As a result, the cost of the body frame 11 can also be reduced.

Also, the upper arm installation areas 72, 73, the lower arm installation areas 82, 83, the first coupling member (upper horizontal portion) 67, the second coupling member 87, the shock absorber supporting portion 79 and the joint (upper connecting pipe) 75 are integrally formed by casting. Therefore it is possible to improve position accuracy of these parts. As a result, ease of assembly of the vehicle can be improved.

In the above embodiment, the description has been made such that the upper arm 71 and the lower arm 81, each of which is shaped substantially like a V, are installed to the body frame 11 in such a manner as to be freely swingable as shown in FIG. 5. However, the present invention is not limited thereto. For example, the upper arm and the lower arm may be a substantially I-shaped arm respectively.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A frame body for an off-road vehicle comprising:
a frame, the frame being substantially rectangular when viewed from a side, the frame comprising:
a front member, a rear member, an upper main member, and a lower main member, the upper and lower main members being coupled through the front and rear members;
two upper arm supporting areas, the upper arm supporting areas being configured to receive and support a wheel so that the wheel is swingable,
two lower arm supporting areas, the lower arm supporting areas being configured to receive and support a wheel so that the wheel is swingable,
a first coupling member disposed between and coupling together the two upper arm supporting areas,
a second coupling member disposed between and coupling together the two upper arm supporting areas, the second coupling member being substantially V-shaped and extending above the first coupling member, the second coupling member being provided with a shock absorber supporting portion for supporting a shock absorber, the shock absorber supporting portion being positioned at or near an apex portion of the second coupling member.

2. The frame body according to claim 1, wherein the upper arm supporting areas, the lower arm supporting areas, the first and second coupling members, and the shock absorber supporting portion have been integrally formed by casting.

3. The body frame according to claim 1, wherein a joint for connecting the upper main member to the frame body is provided in the area on or near the apex portion of the second coupling member.

4. The frame body according to claim 3, wherein the upper arm supporting areas, the lower arm supporting areas, the first and second coupling members, the shock absorber supporting portion and the joint have been integrally formed by casting.

5. A frame body for an off-road vehicle comprising:
a frame, the frame being substantially rectangular when viewed from a side, the frame comprising:
a front member, a rear member, an upper main member, and a lower main member, the upper and lower main members being coupled through the front and rear members;
two upper arm supporting areas, the upper arm supporting areas being configured to receive and support a wheel so that the wheel is swingable;
two lower arm supporting areas, the lower arm supporting areas being configured to receive and support a wheel so that the wheel is swingable;
first coupling means for coupling together the two upper arm supporting areas; and
second coupling means for coupling together the two upper arm supporting areas, the second coupling means extending above the first coupling means,
wherein the second coupling means is provided with a shock absorber supporting means for supporting a shock absorber, the shock absorber supporting means being positioned at or near an apex portion of the second coupling means.
